(19) United States
(12) Patent Application Publication
(10) Pub. No.: US 2017/0373320 A1
(43) Pub. Date: Dec. 28, 2017

(54) ANODE ARCHITECTURE AND ELECTROCHEMICAL CELL INCLUDING ANODE ARCHITECTURE

(71) Applicant: Samsung Electronics Co., Ltd., Suwon-si (KR)

(72) Inventors: Kyounghwan Choi, Suwon-si (KR); Wonsung Choi, Yongin-si (KR)

(21) Appl. No.: 15/398,492

(22) Filed: Jan. 4, 2017

(30) Foreign Application Priority Data
Jun. 24, 2016 (KR) 10-2016-0079287

(51) Int. Cl. H01M 4/62; H01M 12/06; H01M 12/08; H01M 4/38; H01M 4/02

(52) U.S. Cl. CPC H01M 4/628; H01M 12/08; H01M 4/382; H01M 12/06; H01M 2004/027

(57) ABSTRACT

An anode architecture includes: an active metal anode having a first surface and a second surface opposing the first surface, and an oxygen-barrier protection film surrounding the second surface of the active metal anode.

### CROSS-REFERENCE TO RELATED APPLICATION

This application claims the benefit of Korean Patent Application No. 10-2016-0079287, filed on Jun. 24, 2016, in the Korean Intellectual Property Office, and all the benefits accruing therefrom under 35 U.S.C. §119, the content of which is incorporated herein in its entirety by reference.

### BACKGROUND

### 1. Field

The present disclosure relates to an anode architecture, and an electrochemical cell including the same.

### 2. Description of the Related Art

A Lithium-air battery includes an anode that allows deposition/dissolution of metal ions, a cathode that oxides/reduces oxygen in air, and a metal ion conducting medium between the anode and the cathode.

For use as the anode of a lithium-air battery, lithium metal itself is used. Lithium-air batteries do not need to store air, which is a cathode active material, therein. Accordingly, lithium-air batteries having high capacity can be manufactured. Lithium-air batteries can have a theoretical energy density as 3,500 Wh/kg or greater per unit weight. Lithium metal has both ductility, which refers to extension in response to the application of an external force, and malleability, which refers to deformation in response to the application of an external force. Due to these characteristics, handling lithium may be difficult, leading to low processability. To overcome the low processability of lithium, lithium may be deposited on a substrate, for example, a copper substrate. However, when the lithium deposited on the metal substrate is used as an anode, since the metal substrate, which may include a high density metal such as copper, for example, an energy density of a lithium-air battery may be decreased. Regarding a lithium film contacting the copper substrate, a surface of the lithium metal contacting the copper substrate is protected from external environment by to the copper substrate, and side surfaces of the lithium metal may be exposed to the external environment, these side surfaces need additional sealing. Accordingly, there is a need to develop an anode architecture that has improved energy density, improved processability, and addresses the problem of lithium metal exposed on side surfaces, and a lithium air battery including the anode architecture.

### SUMMARY

Provided is an anode architecture including: a lithium metal anode; and an oxygen-barrier protection film simultaneously surrounding second and side surfaces of the lithium metal anode.

Provided is an electrochemical cell including the anode architecture.

Additional aspects will be set forth in part in the description which follows and, in part, will be apparent from the description.

According to an aspect of an embodiment, an anode architecture includes: an active metal anode having a first surface and a second surface opposing the first surface; and an oxygen-barrier protection film surrounding the second surface of the active metal anode.

According to an aspect of an embodiment, an electrochemical cell includes the anode architecture; an ion-conducting film disposed on the active metal anode of the anode architecture; and a cathode disposed on the ion-conducting film.

Also disclosed is a method of manufacturing the anode architecture of claim 1, the method including: providing an active metal anode having a first surface and a second surface opposing the first surface; providing the oxygen-barrier protection film; and disposing the oxygen-barrier protection film on the second surface of the active metal anode.

### BRIEF DESCRIPTION OF THE DRAWINGS

These and/or other aspects will become apparent and more readily appreciated from the following description of the embodiments, taken in conjunction with the accompanying drawings, in which:

FIG. 1A shows a cross-sectional view of an anode architecture according to an embodiment;

FIG. 1B shows a cross-sectional view of an anode architecture according to another embodiment;

FIG. 10 shows a cross-sectional view of an anode architecture including a current collector;

FIG. 2A shows a cross-sectional view of a metal air battery according to an embodiment;

FIG. 2B shows a cross-sectional view of a metal air battery according to an embodiment;

FIG. 3 shows a perspective view of a folded metal air battery according to an embodiment;

FIG. 4 shows a perspective 3-dimensional view of a metal air battery according to an embodiment; and

FIG. 5 is a graph of Normal Stress (megapascals (MPa)) versus Strain (percent, %) and is a graph showing tensile characteristics of the anode architectures manufactured according to Examples 1 and 2 and Comparative Example 1.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. Hereinafter, anode architectures according to example embodiments and electrochemical cells including the same will be described in further detail. “Or” means “and/or.” As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The term “active metal” used herein refers to metal that is used as an electrode active material.

An anode architecture according to an embodiment comprises: an active metal anode having a first surface and a second surface opposing the first surface; and an oxygen-barrier protection film surrounding the second surface of the active metal anode. An anode architecture according to another embodiment comprises: an active metal anode having a first surface, a second surface opposing the first surface, and a side surface between the first surface and the second surface; and an oxygen-barrier protection film surrounding the second surface and side surface of the active metal anode. The oxygen-barrier protection film may be disposed on, e.g., disposed directly on, the second surface and side surface of the active metal anode. Since the anode architecture includes the oxygen-barrier protection film surrounding the second surface and the side surface of the active metal anode, if present, the energy density of the metal air battery per unit weight is increased, and an additional sealing for the side surface of the active metal anode may be avoided. In the anode architecture, the oxygen-barrier protection film may support the active metal anode and may maintain the shape thereof. Accordingly, the oxygen-barrier protection film may function as a carrier film, for example. The carrier film may comprise a material that has improved tensile characteristics compared to that of the active metal anode. Due to the improved tensile characteristics of the anode architecture including the active metal anode disposed on, e.g., attached to the carrier film, the anode architecture may have improved transportability and processability. For example, the anode architecture may include an active metal foil anode disposed on, e.g., attached to the carrier film.

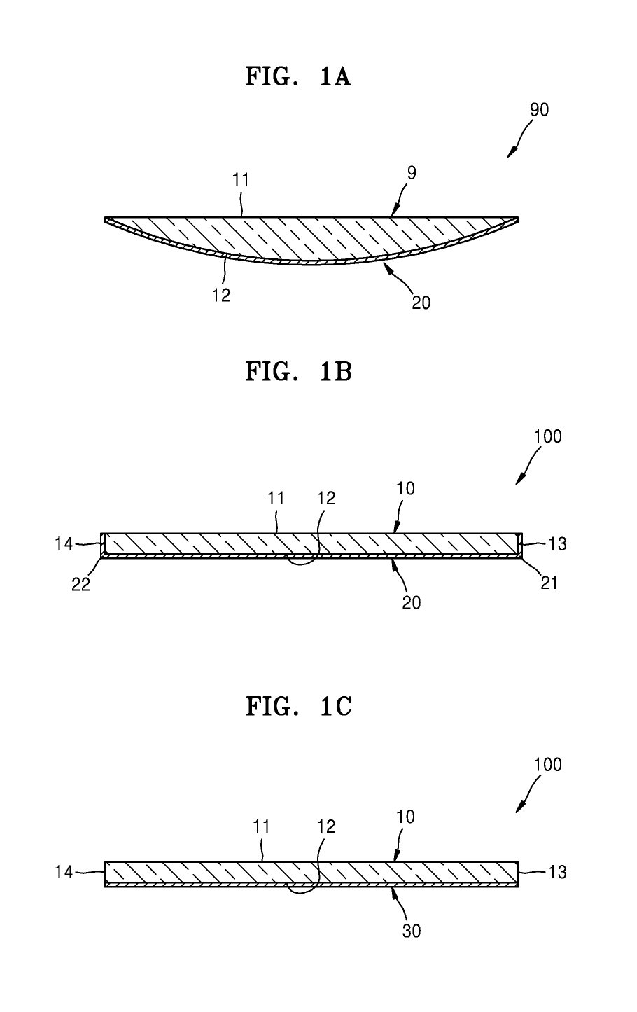

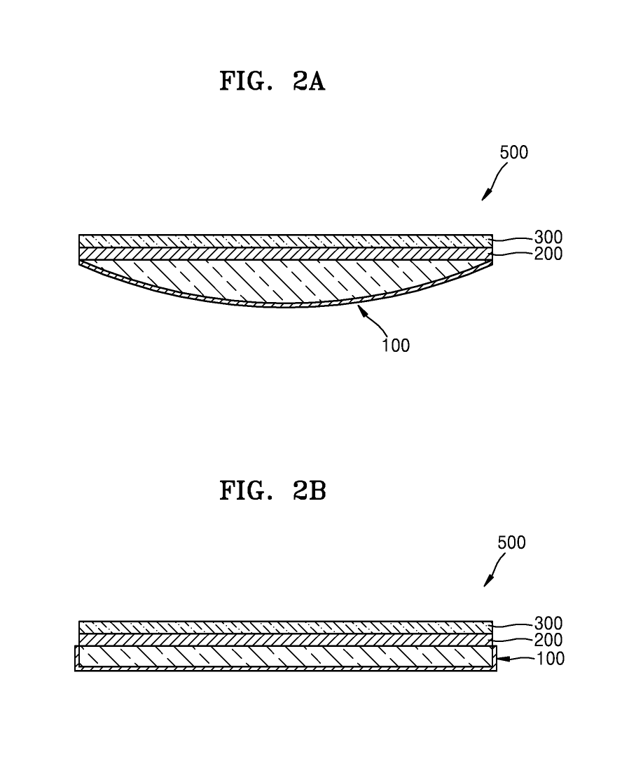

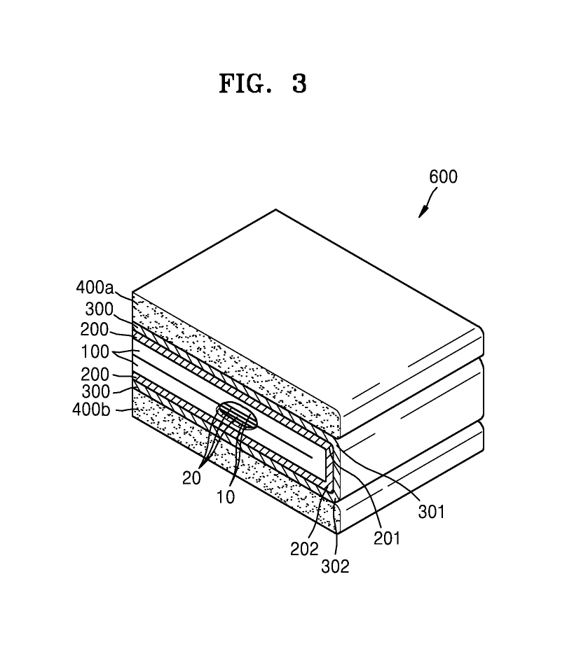

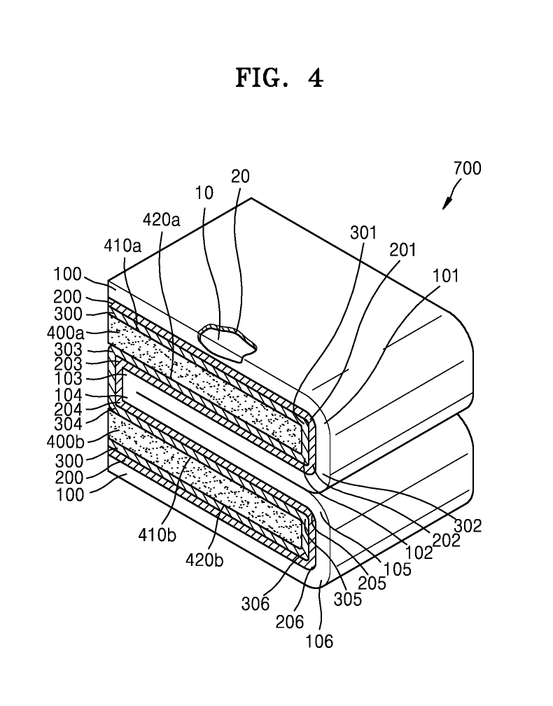

Referring to FIG. 1A, an anode architecture 90 includes: an active metal anode 9 has a first surface 11 and a second surface 12 opposing the first surface; and a protection film 20 surrounding, e.g., disposed on or disposed directly on, the second surface 12 of the active metal anode 10. Referring to FIG. 1B, an anode architecture 100 includes: an active metal anode 10 having a first surface 11, a second surface 12 opposing the first surface, and first and second side surfaces 13 and 14, respectively, between the first surface and the second surface; and a protection film 20 surrounding, e.g., disposed on or disposed directly on, the second surface 12 and the first and second side surfaces 13 and 14, respectively, of the active metal anode 10. In the anode architecture, the protection film 20 may surround the second surface 12 and the first and second side surfaces 13 and 14, respectively and if present, of the active metal anode, and may be disposed directly on the second surface 12 and the first and second side surfaces 13 and 14, respectively, if present. The number and area of side surfaces of the active metal anode 10 depend on the shape of the active metal anode 10. For example, when the active metal anode 10 is rectangular, the protection film 20 surrounds the second surface 12 and four side surfaces of the active metal anode 10 may be present. The shape of the active metal anode and the number and area of side surfaces of the active metal anode is not specifically limited, and may be rectilinear or curvilinear. Use of 2 to about 20, or about 3 to about 10 side surfaces is mentioned.

In the anode architecture 100, the protection film 20 may have one or more folded portions, such as first and second folded portions 21 and 22, respectively, contacting the first and second side surfaces 13 and 14 of the active metal anode 10. Since the protection film 20 is disposed on the second surface 12 and the first and second side surfaces 13 and 14 of the active metal anode 10 at the same time, one or more folded portions, such as first and second folded portions 21 and 22, respectively, are formed at the boundary between the second surface 13 and each of the first and second side surfaces 13 and 14, respectively. For example, when the active metal anode 10 has a circular disc-shape, the protection film 20 may be cylindrical, like a Petri dish. A bending angle of each of the first and second folded portions 21 and 22, respectively, is not particularly limited, and may depend on the shape of the active metal anode 10 or the structure of a battery to be formed. For example, the bending angle of each of the first and second folded portions 21 and 22, respectively, may be about 10 degrees to about 170 degrees. For example, the bending angle of each of the first and second folded portions 21 and 22, respectively, may be in a range of about 30 degrees to about 150 degrees. For example, the bending angle of each of the first and second folded portions 21 and 22, respectively, may be in a range of about 60 degrees to about 120 degrees. For example, the bending angle of each of the first and second folded portions 21 and 22, respectively, may be in a range of about 75 degrees to about 105 degrees. The bending angle of each of the first and second folded portions 21 and 22, respectively, may be an external angle thereof.

In the anode architecture 100, the protection film 20 may not surround, be disposed on, or be disposed directly on the first surface 11 of the active metal anode. In the anode architecture, the protection film 20 may surround the whole surface of the active metal anode other than the first surface 11 thereof. Since the first surface 11 of the active metal anode contacts an electrolyte layer, an electrolyte film, and/or an ion-conducting film, which are distinguishable from the protection film 20, the first surface 11 of the active metal anode may not contact the protection film 20. In other words, in the anode architecture, the first surface 11 of the active metal anode facing a cathode may be surrounded by an electrolyte layer, an electrolyte film, or the like, and the second surface 12 and first and second side surfaces 13 and 14, respectively and if present, of the active metal anode may be surrounded by the protection film 20. An embodiment in which the electrolyte layer, the electrolyte film, or the like, is disposed on, e.g., disposed directly on, the first surface 11 of the active metal anode facing a cathode is also mentioned.

The protection film 20 of the anode architecture may function as a non-permeable film that blocks external liquid and/or gaseous components, such as water vapor or oxygen. Since the protection film 20 suppresses a side reaction between these external components and the active metal anode, lifespan characteristics of a battery including the anode architecture may be improved.

The protection film 20 of the anode architecture may have an oxygen transmission rate of 1,000 cubic centimeters per square meter per day (cm³/m²·day) or less. For example, the oxygen transmission rate of the protection film 20 may be about 500 cm³/m²·day or less. For example, the oxygen transmission rate of the protection film 20 may be about 100 cm³/m²·day or less. For example, the oxygen transmission rate of the protection film 20 may be about 50 cm³/m²·day or less. For example, the oxygen transmission rate of the protection film 20 may be about 10 cm³/m²·day or less. For example, the oxygen transmission rate of the protection film 20 may be 5 cm³/m²·day or less. For example, the oxygen transmission rate of the protection film 20 may be about 1 cm³/m²·day or less. For example, the oxygen transmission rate of the protection film 20 may be about 1000 cm³/m²·day to about 0.001 cm³/m²·day, or about 250 cm³/m²·day to about 0.01 cm³/m²·day. These oxygen transmission rates may be measured using a method of measuring an oxygen transmission rate as described in Evaluation Example 1. Since the protection film 20 has the oxygen transmission rate of about 1,000 cm³/m²·day or less, excellent oxygen barrier properties may be obtained. Thus, the active metal anode may be protected from the external environment, including oxygen, and side reactions of the active metal anode may be suppressed, and ultimately, lifespan characteristics of a battery including the anode architecture comprising the protection film 20 may be improved.

For example, the protection film 20 of the anode architecture 100 may have a water vapor transmission rate of about 500,000 cm³/m²·day or less. For example, the water vapor transmission rate of the protection film 20 may be about 300,000 cm³/m²·day or less. For example, the water vapor transmission rate of the protection film 20 may be 200,000 cm³/m²·day or less. For example, the water vapor transmission rate of the protection film 20 may be about 100,000 cm³/m²·day or less. For example, the water vapor transmission rate of the protection film 20 may be about 50,000 cm³/m²·day or less. For example, the water vapor transmission rate of the protection film 20 may be about 10,000 cm³/m²·day or less. For example, the water vapor transmission rate of the protection film 20 may be about 8,000 cm³/m²·day or less. For example, the water vapor transmission rate of the protection film 20 may be about 500,000 cm³/m²·day to about 100 cm³/m²·day, or about 100,000 cm³/m²·day to about 1000 cm³/m²·day. The water vapor transmission rate of the protection film 20 may be measured using a method of measuring a water vapor transmission rate described in Evaluation Example 1. Since the protection film 20 has the water vapor transmission rate of about 500,000 cm³/m²·day or less, excellent water vapor blocking properties may be obtained. Thus, the active metal anode may be protected from the external environment including water vapor, side reactions of the active metal anode may be suppressed, and ultimately, lifespan characteristics of a battery including the anode architecture 20 may be improved.

The protection film 20 of the anode architecture may be inert, or effectively non-reactive, with respect to an electrode reaction, e.g., inert to lithium. Since the protection film 20 is inert with respect to an electrode reaction of the active metal anode, side reactions which may occur between the active metal anode and the protection film 20 may be prevented. In other words, since the protection film 20 does not engage in an electrochemical reaction that may occur in the oxidation process and/or reduction process of the active metal anode, side-products including metal carbonate, metal oxide, or the like may not be produced on the protection film 20.

The protection film 20 of the anode architecture may be an electron-insulating film. Since the protection film 20 functions as an insulator, a short between the active metal anode and an external conductive member may be prevented. For example, the protection film 20 may have a resistivity of about 1×10¹⁰ ohms-meters (Ω·m) or greater, e.g., about 1×10¹⁰Ω·m to about 1000×10¹⁰Ω·m.

The protection film 20 of the anode architecture may be a non-ion conducting film. The protection film 20 may block oxygen and/or water vapor, and active metal ions at the same time. Accordingly, the protection film 20 may be distinguishable from an electrolyte layer, an electrolyte film, an ion-conducting film, or the like, each having ion conductivity. For example, the protection film 20 may have an ion conductivity of about 1×10⁻⁷ Siemens per centimeter (S/cm) or less. For example, at a temperature of about 25° C., the ion conductivity of the protection film 20 may be about 1×10⁻⁷ S/cm or less. For example, at a temperature of about 25° C., the ion conductivity of the protection film 20 may be about 1×10⁻¹⁰ S/cm or less. For example, the protection film 20 may have an ion conductivity of about 1×10⁻⁷S/cm to about 1×10⁻¹²S/cm. Since the protection film 20 does not conduct ions, were the protection film 20 to surround the first surface 11 of the active metal anode facing a cathode, the migration of ions between the cathode 300 and an anode would be substantially blocked, and thus, the operation of a battery would stop. Accordingly, the protection film 20, being a non-ion conducting, may surround the second surface 12 and side surfaces 13 and 14, respectively and if present, of the active metal anode.

The protection film 20 of the anode architecture may not include a lithium salt. Since the protection film 20 does not include a lithium salt, improved oxygen and/or water vapor barrier properties may be provided. Since the protection film 20 does not include a lithium salt, the protection film 20 is distinguishable from an electrolyte film and/or ion-conducting film 200 which includes a lithium salt.

The protection film 20 of the anode architecture may have a thickness of about 0.1 micrometers (μm) or greater. When the thickness of the protection film 20 is too small, oxygen barrier properties may be reduced. The upper limit of the thickness of the protection film 20 is not limited as long as processability and the energy density per unit volume of a battery are not unsuitably decreased. For example, the thickness of the protection film 20 of the anode architecture may be in a range of about 0.1 μm to about 100 μm. For example, the thickness of the protection film 20 of the anode architecture may be in a range of about 1 μm to about 80 μm. For example, the thickness of the protection film 20 of the anode architecture may be in a range of about 5 μm to about 70 μm. For example, the thickness of the protection film 20 of the anode architecture may be in a range of about 10 μm to about 50 μm.

The tensile strength of the anode architecture may be 1.5 megaPascals (MPa) or greater. When the tensile strength of the anode architecture is too low, the anode architecture may be deformed even by weak force, thereby failing to retain the original shape thereof, leading to low processability. The upper limit of the tensile strength is not limited as long as the processability is not lowered. For example, the tensile strength of the anode architecture may be about 2 MPa or greater. For example, the tensile strength of the anode architecture may be about 2.2 MPa or greater. For example, the tensile strength of the anode architecture may be about 3 MPa or greater. For example, e tensile strength of the anode architecture may be about 5 MPa or greater. For example, the tensile strength of the anode architecture may be about 10 MPa or greater. For example, e tensile strength of the anode architecture may be about 1.5 MPa to about 100 MPa. Tensile strength is a measurement of the force required to pull the anode architecture to the point where it breaks.

The anode architecture may have a strain of about 7% or less. When the strain of the anode architecture is too high, the anode architecture may easily extend, leading to low processability. For example, the strain of the anode architecture may be about 6% or less. For example, the strain of the anode architecture may be about 5% or less. For example, the strain of the anode architecture may be about 4% or less. For example, the strain of the anode architecture may be about 7% to about 1%. Strain is defined as “deformation of a solid due to stress” and can be expressed as ε=dl/lo=σ/E where dl=change of length, lo=initial length, ε=strain, E=tensile modulus (N/m2 (Pa), lb/in2 (psi))

The protection film 20 of the anode architecture may be an organic film or an organic-inorganic composite film. The protection film 20 may be an organic film including an oxygen barrier polymer or an organic-inorganic composite film including an oxygen barrier polymer and an inorganic material. The protection film 10 may include a polymer that blocks oxygen and water vapor.

For example, the protection film 20 may include at least one selected from polyvinylalcohol; and a polyvinylalcohol blend.

Polyvinylalcohol may include a free hydroxyl group. The greater number of free hydroxyl-groups polyvinylalcohol has, the lower oxygen diffusion rate, and thus, an oxygen barrier effect may be improved. Since the saponification degree of polyvinylalcohol affects the number of free hydroxyl groups included in polyvinylalcohol, the saponification degree of polyvinylalcohol affects oxygen barrier properties of the protection film 20. The saponification degree of polyvinylalcohol may be about 85 mole percent (mol %) or greater. For example, the saponification degree of polyvinylalcohol may be about 95 mol % or greater, For example, the saponification degree of polyvinylalcohol may be in a range of about 85 to about 99.9 mol %, for example, about 88 to about 98 mol %. When the saponification degree of polyvinylalcohol is within these ranges, filming properties and oxygen barrier properties of the protection film 20 may be improved.

The polyvinylalcohol blend may include polyvinylalcohol and a first polymer that has excellent miscibility with respect to polyvinylalcohol. In an embodiment, the first polymer may include at least one selected from polymethylmethacrylate, polymethylacrylate, polyethyl methacrylate, polyethylacrylate, polypropylmethacrylate, polypropylacrylate, polybutylacrylate, polybutylmethacrylate, polypentylmethacrylate, polypentylacrylate, polycyclohexylmethacrylate, polycyclohexylacrylate, polyhexylmethacrylate, polyhexylacrylate, polyglycidylacrylate, polyglycidylmethacrylate, and polyacrylonitrile. An amount of the first polymer may be, based on 100 parts by weight of the polyvinylalcohol, in a range of about 0.1 parts by weight to about 100 parts by weight, for example, about 20 parts by weight to about 100 parts by weight, based on 100 parts by weight of the polyvinylalcohol.

For example, the protection film 20 may include at least one selected from a polymerization product of at least one multi-functional monomer selected from a multi-functional (meth)acryl-based monomer and a multi-functional vinyl-based monomer; and a polymerization product of at least one multi-functional monomer selected from a multi-functional (meth)acryl-based monomer and a multi-functional vinyl-based monomer and a polythiol having three or four thiol groups. The (meth)acryl polymer includes any polymer derived from polymerization of an acryl or a methacryl monomer, e.g., acrylonitrile, methacrylonitrile, acrylamide, methacrylamide, acrylic acid, methacrylic acid, or a (C1-C8 alkyl) ester of acrylic or methacrylic acid. Acryl polymers are preferred.

A multi-functional monomer may include at least one selected from diurethane dimethacrylate, trimethylolpropane triacrylate, diurethane diacrylate, trimethylolpropane trimethacrylate, neopentyl glycol diacrylate, 3′-acryloxy-2′,2′-dimethylpropyl 3-acryloxy-2,2-dimethylpropionate, bisphenol A diacrylate, and 1,3,5,-triallyl-1,3,5-triazine-2,4,6-trione, and the polythiol may include at least one selected from pentaerythritol tetrakis(3-mercaptopropionate), trimethylolpropane tris(3-mercaptopropionate), 4-mercaptomethyl-3,6-dithia-1,8-octanedithiol, and pentaerythritol tetrakis(2-mercaptoacetate), trimethylolpropane tris(2-mercaptoacetate).

For example, the protection film 20 may include at least one selected from polyvinylalcohol; a blend of polyvinylalcohol and at least one polymer selected from polymethylmethacrylate, polymethylacrylate, polyethyl methacrylate, polyethylacrylate, polypropylmethacrylate, polypropylacrylate, polybutylacrylate, polybutylmethacrylate, polypentylmethacrylate, polypentylacrylate, polycyclohexylmethacrylate, polycyclohexylacrylate, polyhexylmethacrylate, polyhexylacrylate, polyglycidylacrylate, polyglycidylmethacrylate and polyacrylonitrile; and a polymerization product of pentaerythritol tetrakis(3-mercaptopropionate), and 1,3,5-triallyl-1,3,5-triazine-2,4,6-trione.

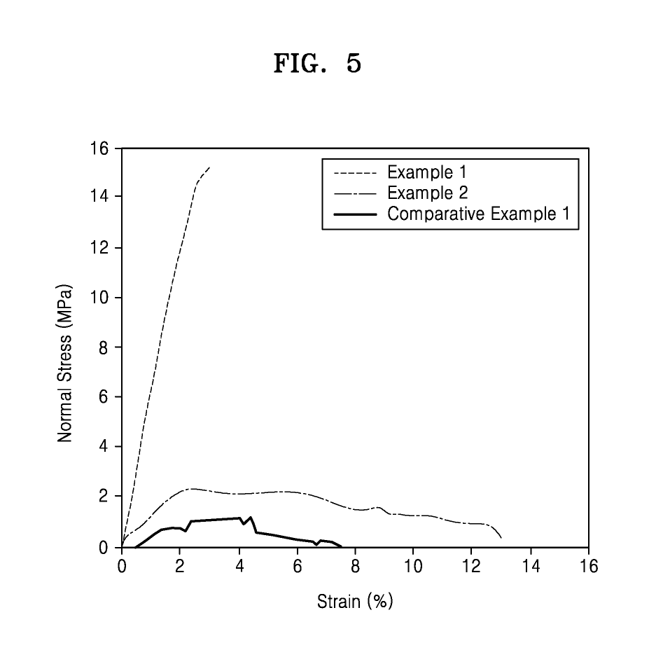

Referring to FIG. 1A, in the anode architecture 90, a current collector may be omitted, i.e., may not be disposed between the active metal anode 9 and the protection film 20. Referring to FIG. 1B, in the anode architecture 100, a current collector may be omitted, i.e., may not be disposed between the active metal anode 10 and the protection film 20. Since the anode architecture does not include the current collector between the active metal anode and the protection film 20, the energy density per unit weight of a battery including the anode architecture may be substantially increased. Referring to FIG. 10, in the anode architecture 110, the active metal anode 10 is surrounded by a current collector 30. Since the second surface 12 of the active metal anode 10 is surrounded by the current collector 30, the weight of the anode architecture 110 may be substantially increased, and, accordingly, the energy density per unit weight of a battery including the anode architecture 110 may be substantially decreased. In the anode architecture 110, the first and second side surfaces 13 and 14, respectively, of the active metal anode 10 are not surrounded by the current collector 30, and thus additional sealing may be desired to provide suitable performance.

Referring to FIGS. 1A and 1B, since the anode architectures 90 and 100 do not include a metal current collector that may otherwise be disposed between the active metal anode and the protection film 20, the weight of the anode architecture may be substantially decreased. The anode architecture may include, instead of a substrate and/or a mesh-shaped current collector, which are to be disposed parallel to the active metal anode and between the active metal anode and the protection film 20, a conductive terminal (not shown) extending from the second surface and/or side surfaces of the active metal anode to the outside the anode architecture through the protection film 20. The conductive terminal may include a conductive material, such as a metal, such as aluminum or copper. Due to the inclusion of the conductive terminal extending from the second surface and/or side surfaces of the active metal anode 10 to the outside the anode architecture through the protection film 20, the weight of the anode architecture may be substantially decreased.

Referring to FIGS. 1A and 1B, an active metal constituting the active metal anodes 9 and 10 of the anode architectures 90 and 100, respectively, may comprise alkali metal (for example, lithium, sodium, or potassium), alkaline earth metal (for example, calcium, magnesium, or barium, and/or certain transition metals (for example, zinc or an alloy thereof).

In an embodiment, the active metal constituting the active metal anode of the anode architecture may include at least one selected from lithium and a lithium alloy.

The active metal may be lithium metal. The lithium metal may be a lithium metal foil. When the active metal is lithium metal foil, the volume and weight of the metal air battery may be decreased as much as the volume and weight of a current collector. Accordingly, the energy density per unit weight of the metal air battery may be increased.

In an embodiment, the active metal may be an alloy of an anode active material that is different from lithium metal. The anode active material may be lithium-alloyable metal. The lithium-alloyable metal may be Si, Sn, Al, Ge, Pb, Bi, Sb, a Si—Y′ alloy (where Y′ is alkali metal, alkaline earth metal, a Group 13 element, a Group 14 element, transition metal, a rare-earth element, or a combination thereof, and is not Si), a Sn—Y′ alloy (where Y′ is alkali metal, alkaline earth metal, a Group 13 element, a Group 14 element, transition metal, a rare-earth element, or a combination thereof, and is not Sn). The Y′ may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof. For example, lithium alloy may be lithium aluminum alloy, lithium silicon alloy, lithium tin alloy, lithium silver alloy, or lithium lead alloy.

The active metal anode of the anode architecture may have a thickness of about 10 μm or greater. The thickness of the active metal anode 10 may be in a range of about 10 μm to about 20 μm, about 20 μm to about 60 μm, about 60 μm to about 100 μm, about 100 to about 200 μm, about 200 μm to about 600 μm, about 600 μm to about 1,000 μm, about 1 mm to about 6 mm, about 6 mm to about 10 mm, about 10 mm to about 60 mm, about 60 mm to about 100 mm, or about 100 mm to about 600 mm.

An electrochemical cell according to an embodiment includes an anode architecture; an ion-conducting film disposed on an active metal anode constituting the anode architecture; and a cathode disposed on the ion-conducting film.

Referring to FIGS. 2A and 2B, the electrochemical cell 500 may be a metal air battery. For example, the metal air battery may be a lithium air battery or a sodium air battery.

Since the metal air battery includes the anode architecture, the energy density per unit weight of the metal air battery is increased and an additional sealing on a side surface of the metal air battery is not needed.

Referring to FIG. 2A, a metal air battery 500 according to an embodiment includes an anode architecture 90; an ion-conducting film 200 disposed on the active metal anode 9 of the anode architecture 90; and a cathode 300 disposed on the ion-conducting film 200.

Referring to FIG. 2B, a metal air battery 500 according to an embodiment includes an anode architecture 100; an ion-conducting film 200 disposed on the active metal anode 10 of the anode architecture 100; and a cathode 300 disposed on the ion-conducting film 200.

The ion-conducting film 200 of the metal air battery 500 may be an active metal ion-conducting solid membrane. The ion-conducting film 200 may be substantially non-permeable, and may conduct active metal ions, and may be compatible with an external environment including oxygen, water vapor, or the like, and the cathode 300 environment. The ion-conducting film 200 may be a gas and water vapor barrier film. Since a gas, for example, oxygen and water vapor are blocked by the ion-conducting film 200, oxygen or water vapor-induced deterioration of the active metal anode included in the anode architecture in a non-transmissible housing including the ion-conducting film 200 and a protection film of the anode architecture may be prevented.

A thickness of the ion-conducting film 200 may be 10 μm or greater. The thickness of the ion-conducting film 200 may be in a range of about 10 μm to about 20 μm, about 20 μm to about 60 μm, about 60 μm to about 100 μm, about 100 μm to about 200 μm, about 200 μm to about 600 μm, about 600 μm to about 1000 μm, about 1 mm to about 6 mm, about 6 mm to about 10 mm, about 10 mm to about 60 mm, about 60 to about 100 mm, or about 100 mm to about 600 mm.

For example, the ion-conducting film 200 may be an organic film including a lithium salt and a polymer that has water vapor and/or oxygen barrier characteristics. Since the polymer that has water vapor and/or oxygen barrier characteristics and the lithium salt are mixed, the gas and water vapor barrier characteristics and ion conductivity may be simultaneously provided to the ion-conducting film 200.

Examples of the polymer having the gas and water vapor barrier characteristics include one selected from poly(2-vinyl pyridine); polytetrafluoroethylene; a tetrafluoroethylene-hexafluoropropylene copolymer; polychlorotrifluoroethylene; a perfluoroalkoxy copolymer; fluorinated cyclic ether; polyethylene oxide diacrylate; polyethylene oxide dimethacrylate; polypropylene oxide diacrylate; polypropylene oxide dimethacrylate; polymethylene oxide diacrylate; polymethylene oxide dimethacrylate; polyalkyldiol diacrylate; polyalkyldiol dimethacrylate; polydivinylbenzene; polyether; polycarbonate; polyimide; polyester; polyvinyl chloride; polyimide; polycarboxylic acid; polysulfonic acid; polyvinyl alcohol; polysulfone; polystyrene; polyethylene; polypropylene; poly(p-phenylene); polyacetylene; poly(p-phenylene vinylene); polyaniline; polypyrrole; polythiophene; poly(2,5-ethylene vinylene); polyacene; poly(naphthalene-2,6-diyl); polyethylene oxide; polypropylene oxide; polyvinylidene fluoride; a copolymer of vinylidene fluoride and hexafluoropropylene; polyvinyl acetate; poly(vinyl butyral-co-vinyl alcohol-co-vinyl acetate); poly(methyl methacrylate-co-ethyl acrylate); polyacrylonitrile; polyvinyl chloride-co-vinyl acetate; poly(l-vinylpyrrolidone-co-vinyl acetate); polyvinylpyrrolidone; polyacrylate; polymethacrylate; polyurethane; polyvinyl ether; acrylonitrile-butadiene rubber; styrene-butadiene rubber; acrylonitrile-butadiene-styrene rubber; a sulfonated styrene/ethylene-butylene triblock copolymer; a polymer obtained from at least one acrylate monomer selected from ethoxylated neopentyl glycol diacrylate, ethoxylated bisphenol A diacrylate, ethoxylated aliphatic urethane acrylate, ethoxylated alkylphenol acrylate, and a (C1-C8 alkyl) acrylate; polyvinyl alcohol; polyimide; an epoxy resin; an acrylic resin; and combinations thereof but are not necessarily limited thereto. The polymer having the gas and water vapor barrier characteristics may include any polymer as long as the polymer has gas and water vapor barrier characteristics in the art. In one embodiment, the polymer that has the water vapor and/or oxygen barrier characteristics may be used as an oxygen and water vapor-barrier polymer constituting a protection film of the anode architecture 100.

The lithium salt may be LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₆)₂, LiC(SO₂CF₃)₃, LiN(SO₃CF₃)₂, LiC₄F₉SO₃, LiAlCl₄, or the like, but is not limited thereto. The lithium salt may be any material that is used as a lithium salt in the art.

In an embodiment, the ion-conducting film 200 may be a composite film including an organic film having a plurality of pores and an ion-conducting polymer electrolyte formed in the pores.

The organic film having a plurality of pores may be a porous organic film in which a plurality of pores are irregularly arranged in an organic film. The porous organic film may be a polymer-based separator film. The pores of the porous organic film may be filled with the ion-conducting polymer electrolyte. For example, the porous organic film may be impregnated with the ion-conducting polymer electrolyte. Since a flow path formed by the connection of a plurality of pores irregularly arranged is impregnated with a polymer electrolyte, the polymer electrolyte may be exposed to opposing surfaces of the composite film, providing a mobility path for active metal ions.

The porous organic film may be a porous film including a polymer non-woven fabric, such as a non-woven fabric formed of polypropylene, a non-woven fabric formed of polyimide, or a non-woven fabric formed of polyphenylene sulfite, or an olefin-based resin, such as polyethylene, polypropylene, polybutene, or polyvinylchloride. However, a material for forming the porous organic film is not limited thereto, and may be any material that is used in preparing a porous organic film in the art.

The ion-conducting polymer electrolyte may include at least one selected from polyethylene oxide (PEO), polyvinylalcohol (PVA), polyvinylpyrrolidone (PVP), and polysulfone. However, the ion-conducting polymer electrolyte is not limited thereto, and may be any polymer that is used as an ion-conducting polymer electrolyte used in the art.

The ion-conducting polymer electrolyte may include a lithium salt. The lithium salt may be selected from the lithium salts described above.

In an embodiment, the ion-conducting film 200 may be a composite film including an organic film having a plurality of through-holes and ion-conducting inorganic particles located in the through-holes of the organic film.

The through-holes refer to pores of the organic film, having a first surface and a second surface opposing the first surface, passing through the first surface and the second surface. Since ion-conducting inorganic particles in the through-holes are exposed to the facing surfaces of the organic film, the ion-conducting inorganic particles provide a mobility path for active metal ions.

The porous organic film including the through-holes may be a non-ion conducting region. The porous organic film including the through-holes may not include a lithium salt. The ion-conducting inorganic particles may function as an ion-conducting region.

The ion-conducting film 200 includes an ion-conducting region and a non-ion conducting region, and the ion-conducting region and the non-ion conducting are arranged to contact each other in a thickness direction of the ion-conducting film 200 (Y-axis direction), thereby having a bicontinuous structure. The ion-conducting region may include ion-conducting inorganic particles, and the non-ion conducting region may include a polymer. The ion-conducting inorganic particles may comprise particles that do not have a grain boundary. The ion-conducting film 200 including ion-conducting inorganic particles exposed to the surface of the organic film is a composite film that has ion conductivity and high mechanical strength caused by high flexibility, and is easy to be processed according to purpose.

An organic film having a plurality of pores or an organic film having a plurality of through-holes may include a polymer having gas and water vapor barrier characteristics.

Since the organic film of the ion-conducting film 200 blocks gas and water vapor, the ion-conducting film 200 may protect the active metal anode 10 of the anode architecture 100.

The polymer having gas and water vapor barrier characteristics may be a gas and water vapor barrier polymer.

The ion-conducting inorganic particles may include at least one selected from glass or amorphous metal ion conductor, ceramic active metal ion conductor, and glass ceramic active metal ion conductor. The ion-conducting inorganic particles may also have gas and water vapor barrier characteristics.

The ion-conducting inorganic particles may include at least one selected from BaTiO₃, Pb(Zr,Ti)O₃(PZT), Pb₁₋ₓLaₓZr_{1-y} Ti_{y}O₃(PLZT)(0≦x<1, 0≦y<1), Pb(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, lithium phosphate (Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3), Li_{1+x+y}(Al, Ga)ₓ(Ti, Ge)₂₋ₓSi_{y}P_{3-y}O₁₂ (0≦x≦1, 0≦y≦1), lithium lanthanum titanate (LiₓLa_{y}TiO₃, 0<x<2, 0<y<3), lithium germanium thiophosphate (LixGeyPzSw, 0<x<4, 0<y<1, 0<z<1, 0<w<5), lithium nitride (LiₓN_{y}, 0<x<4, 0<y<2), SiS₂(LiₓSi_{y}S_{z}, 0<x<3,0<y<2, 0<z<4)-based glass, P₂S₅(LiₓP_{y}S_{z}, 0<x<3, 0<y<3, 0<z<7)-based glass, Li₂O, LiF, LiOH, Li₂CO₃, LiAlO₂, Li₂O—Al₂O₃—SiO₂—P₂O₅—TiO₂—GeO₂-based ceramics, and a garnet-based ceramic such as Li₃₊ₓLa₃M₂O₁₂ (M is selected from Te, Nb, and Zr). However, the ion-conducting inorganic particles are not limited thereto, and may be any suitable material that is used as ion-conducting inorganic particles in the art.

The particles of the ion-conducting inorganic particles may comprise or consist of a single grain or crystallite, that is not have, as described above, a grain boundary, and accordingly, a composite film having such ion-conducting inorganic particles may provide an active metal ion-conducting path having a low resistance. As a result, the composite film may highly conduct active metal ions and may allow them to move therethrough. Accordingly, the composite film may be highly conductive with respect to active metal ions and the lithium-ion transference number thereof may be substantially improved. Compared to a film that consists of inorganic particles alone, the composite film may have higher flexibility and greater mechanical strength.

The ion-conducting inorganic particles being in the form of a single particle without the grain boundary may be identified by scanning electron microscope (SEM).

An average diameter of the ion-conducting inorganic particles may be in a range of about 10 μm to about 300 μm, for example, about 90 μm to about 125 μm. When the average diameter of the ion-conducting inorganic particles is within these ranges, the ion-conducting film 200 including ion-conducting inorganic particles in the form of a single particle that does not have a grain boundary may be obtained by, for example, polishing in preparing a composite film, may be obtained.

Ion-conducting inorganic particles may have a uniform size, and may maintain its uniform size in the composite film. For example the ion-conducting inorganic particles may have D50 of about 110 μm to about 130 μm, D90 of about 180 μm to about 200 μm, and D10 of about 60 μm to about 80 μm. Herein, the terms “D50,” “D10,” and “D90” respectively mean particle diameter corresponding to 50 vol. %, 10 vol. %, and 90 vol. % in a cumulative distribution curve.

The ion-conducting film 200 may have a single-layered structure or a multi-layered structure.

When the ion-conducting film 200 has a single-layered structure, the ion-conducting film 200 may be an organic film including a lithium salt and the gas and water vapor barrier polymer; a composite film including an organic film having a plurality of pores and an ion-conducting polymer electrolyte located in the pores; or a composite film including an organic film having a plurality of through-holes and ion-conducting inorganic particles located in the through-holes.

The ion-conducting film 200 may be manufactured at relatively low costs compared to an inorganic film including a ceramic material of the related art, and the organic film/composite film may enable manufacture of large-size, thin-filmed, and light-weight products. The organic film/composite film may also enable manufacture of a battery having longer lifespan. When the ion-conducting film 200 has a single-layered structure, a thickness of the conducting film 200 may be in a range of about 10 μm to about 100 μm, or about 100 μm to about 300 μm.

When the ion-conducting film 200 has a multi-layered structure, the ion-conducting film 200 may have a stack of an organic film/composite film having gas and water vapor barrier characteristics and a polymer electrolyte film. Since the polymer electrolyte film, which is chemically compatible with an anode and an organic film/composite film, is disposed between the organic film/composite film and an active metal anode, stability of the composite film may be improved.

A thickness of the polymer electrolyte film disposed between the organic film/composite film and the active metal anode may be 10 μm or greater. The thickness of the polymer electrolyte film may be in a range of about 10 μm to about 100 μm, or about 100 μm to about 300 μm. The polymer electrolyte film may include lithium salt-doped polyethyleneoxide. The lithium salt used for the doping may be the same as used in preparing the ion-conducting polymer electrolyte.

A porous film may be additionally disposed between the organic film/composite film and the polymer electrolyte film or between the polymer electrolyte film and the active metal anode.

The porous film may be any suitable film that has excellent mechanical characteristics and high heat resistance and has pores therein. In an embodiment, the porous film may include at least one selected from an olefin-based polymer that has high resistance to chemicals and hydrophobicity; and a sheet or non-woven fabric formed of, for example, glass fiber or polyethylene. Examples of the olefin-based polymer include at least one selected from polyethylene, and polypropylene. For example, the porous film including the olefin-based polymer may comprise a mixed multi-layered film, and examples of such a film include a two-layered separator having a polyethylene/polypropylene structure, a three-layered separator having a polyethylene/polypropylene/polyethylene structure, and a three-layered separator having a polypropylene/polyethylene/polypropylene structure.

The porous film may be a polyethylene film, a polypropylene film, or a combination thereof. An average diameter of pores of the porous film may be in a range of, for example, about 0.01 μm to about 10 μm. The thickness of the porous film may be 10 μm or greater. In an embodiment, the thickness of the porous film may be in a range of about 10 μm to about 100 μm, or about 100 μm to about 300 μm. The thickness of the porous film may be in a range of, for example, about 10 μm to about 50 μm.

In an embodiment, the porous film may include an electrolytic solution including a lithium salt and an organic solvent. When the electrolytic solution is included, the formed porous film may act as an electrolyte film.

An amount of the lithium salt may be in a range of about 0.01 molar (M) to about 5 M, for example about 0.2 M to about 2M. When the amount of the lithium salt is within these ranges, the formed composite film may have excellent conductivity.

The lithium salt may be dissolved in a solvent to provide lithium ions in a battery. The lithium salt may include at least one selected from LiPF₆, LiBF₄, LiSbF₆, LiAsF₆, LiN(SO₂C₂F₅)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂)(where x and y are natural numbers), LiF, LiBr, LiCl, LiOH, LiI, and LiB(C₂O₄)₂ [lithium bis(oxalato) borate (LiBOB).

The electrolytic solution may further include, in addition to the lithium salt, other metal salts, AlCl₃, MgCl₂, NaCl, KCl, NaBr, KBr, and CaCl₂.

The solvent used herein may be an aprotic solvent.

The aprotic solvent may comprise at least one selected from a carbonate-based solvent, an ester-based solvent, an ether-based solvent, a ketone-based solvent, an amine-based solvent, and a phosphine-based solvent.

The carbonate-based solvent may comprise at least one selected from dimethyl carbonate (DMC), diethyl carbonate (DEC), ethylmethyl carbonate (EMC), dipropyl carbonate (DPC), methylpropyl carbonate (MPC), ethylpropyl carbonate (EPC), methylethyl carbonate (MEC), ethylene carbonate (EC), propylene carbonate (PC), and butylene carbonate (BC).

The ester-based solvent may comprise at least one selected from methyl acetate, ethyl acetate, n-propyl acetate, dimethyl acetate, methyl propionate, ethyl propionate, γ-butyrolactone, decanolide, valerolactone, mevalonolactone, and caprolactone.

The ether-based solvent may comprise at least one selected from dibutyl ether, tetraglyme, diglyme, dimethoxyethane, 2-methyltetrahydrofuran, and tetrahydrofuran. The ketone-based solvent may comprise cyclohexanone, or the like.

The amine-based solvent may be triethylamine, triphenylamine, or the like. The phosphine-based solvent may be triethylphosphine or the like. However, the solvent is not limited to these solvents, and may be any suitable aprotic solvent that is used in the art.

In an embodiment, examples of the aprotic solvent include nitriles, such as compounds of the formula R—CN (wherein R is a linear, branched, or cyclic C₂ to C₃₀ hydrocarbon group, and may include a double bond, an aromatic ring, or an ether bond); amides, such as dimethylformamide; dioxolanes, such as 1,3-dioxolane, and sulfolanes.

The solvents may be used alone or in combination, and when used in combination, the content ratio may be appropriately controlled according to performance of a battery.

The porous film may include an ionic liquid.

The ionic liquid may be a compound that comprises a linear, branched substituted ammonium, imidazolium, pyrrolidinium, or piperidinium cation and an anion, such as PF₅⁻, BF₄⁻, CF₃SO₃⁻, (CF₃SO₂)₂N⁻, (C₂F₅SO₂)₂N⁻, (C₂F₅SO₂)₂N⁻, or (CN)₂N⁻.

The cathode 300, which uses oxygen as a cathode active material in the metal air battery 500, may be prepared using a conductive material.

The conductive material may be porous. Accordingly, any suitable porous conductive material that has suitable porosity and conductivity may be used without any limitation. For example, the conductive material may be a porous carbonaceous material. The carbonaceous material may be a carbon black-based material, a graphite-based material, a graphene-based material, an activated carbon-based material, a carbon fiber-based material, or the like. In detail, the carbonaceous material may include at least one selected from a carbon nanoparticle, a carbon nanotube, for example: a single-walled carbon nanotube (SWCNT) or multi-walled carbon nanotube (MWCNT), a carbon nanofiber, a carbon nanosheet, a carbon nanorod, and a carbon nanobelt, but is not limited thereto. The carbonaceous material used herein may be any suitable carbonaceous material that has a nanostructure. The carbonaceous material may have, in addition to the nanostructure, a micro-size. For example, the carbonaceous material may have various micro-size shapes, and may have the shape of particle, tube, fiber, sheet, rod, belt, or the like. For example, the carbonaceous material may be a mesoporous. For example, the carbonaceous material may be completely or partially porous. Due to the inclusion of the porous carbonaceous material, the cathode 300 may be porous, and provide a porous cathode. Since the carbonaceous material is porous, the cathode 300 may have more contact with an electrolyte. In addition, within the cathode 300, oxygen may be easily supplied and diffused, and a space for housing charging and discharging products may be provided.

In an embodiment, the conductive material may be a metallic, conductive material, such as metal fiber or metal mesh. In an embodiment, the conductive material may be a metallic powder, such as copper powder, silver powder, nickel powder, or aluminum powder. In an embodiment, the conductive material may be an organic conductive material, such as polyphenylene derivative. The conductive material may be used alone or in a combination.

The cathode 300 may further include, in addition to the porous material, an electrolyte. That is, the cathode 300 may be a composite cathode. The electrolyte may include at least one selected from a polymer electrolyte, an inorganic electrolyte, an organic and inorganic composite electrolyte, and an ionic liquid. When the cathode 300 includes the electrolyte, in the cathode 300, oxygen may easily diffuse, and the electrolyte may have more contact with the oxygen. In the cathode 300, a composition ratio of the porous material to the electrolyte may be in a range of 1:2 to 1:9, based on weight. That is, based on 100 parts by weight of the porous material, the amount of the electrolyte may be in a range of about 200 to about 900 parts by weight. Within this range, a formed lithium air battery may have improved charging and discharging characteristics. The electrolyte may be, for example, as the ionic liquid, N,N-diethyl-methyla mine trifluoromethanesulfonate (DEMA), 1-methyl-3-propylpyrrolidinium bis(trifluoromethanesulfonyl)imide (PP13TFSI), or N-methyl-N-propylpiperidinium bistrifluoromethanesulfonyl amide (PP13-TFSA). The electrolyte may include at least one selected from polyethylene oxide (PEO), polyvinylalcohol (PVA), polyvinylpyrrolidone (PVP), and polysulfone, and lithium doped thereon. For example, the ion-conducting electrolyte may be a lithium salt-doped polyethylene oxide.

A catalyst for oxidizing/reducing oxygen may be added to the cathode 300 of the metal air cell. Examples of the catalyst may include at least one selected from a noble metal-based catalyst such as platinum, gold, silver, palladium, ruthenium, rhodium, and osmium; an oxide-based catalyst such as at least one selected from manganese oxide, iron oxide, cobalt oxide, and nickel oxide; an organic metal-based catalyst such as cobalt phthalocyanine; and combinations thereof, but are not limited thereto. The catalyst may include any suitable material as long as the material is applicable to a catalyst for oxidizing/reducing oxygen in the art

In addition, the catalyst may be impregnated in a carrier. Examples of the carrier may include at least one selected from an oxide, a zeolite, a clay mineral, and carbon. Examples of the oxide may include at least one selected from alumina, silica, zirconium oxide, and titanium dioxide. Examples of the oxide may include an oxide including at least one selected from cerium (Ce), praseodymium (Pr), samarium (Sm), europium (Eu), terbium (Tb), thulium (Tm), ytterbium (Yb), antimony (Sb), bismuth (Bi), vanadium (V), chromium (Cr), manganese (Mn), iron (Fe), cobalt (Co), nickel (Ni), copper (Cu), niobium (Nb), molybdenum (Mo), and tungsten (W). Examples of the carbon may include at least one selected from carbon black such as KETJEN black, acetylene black, channel black, or lamp black, graphite such as natural graphite, artificial graphite, or expanded graphite, activated carbon, and a carbon fiber, but are not limited thereto. The carbon may include any suitable material as long as the material is applicable to a carrier in the art.

The cathode 300 may additionally include a binder. Examples of the binder may include at least one selected from a thermoplastic resin and a thermosetting resin. Examples of the binder may include at least one selected from polyethylene, polypropylene, polytetrafluoroethylene (PTFE), polyvinylidene fluoride (PVDF), styrene-butadiene rubber, a tetrafluoroethylene-perfluoroalkyl vinyl ether copolymer, a vinylidene fluoride hexafluoropropylene copolymer, a vinylidene fluoride/chlorotrifluoroethylene copolymer, an ethylene-tetrafluoroethylene copolymer, a polychloro-trifluoroethylene copolymer, a vinylidene fluoride-pentafluoropropylene copolymer, a propylene-tetrafluoroethylene copolymer, an ethylene-chloro-trifluoroethylene copolymer, a vinylidene fluoride-hexafluoropropylene-tetrafluoroethylene copolymer, a vinylidene fluoride-perfluoroalkyl vinyl ether-tetrafluoroethylene copolymer, and an ethylene-acrylic acid copolymer, which can be used solely or in a combination. However, the binder is not limited thereto and may include any suitable material as long as the material is applicable to a binder in the art.

The cathode 300 may be prepared by, for example, mixing the conductive material, the binder, and the catalyst for oxidizing/reducing oxygen, adding an appropriate solvent to the resultant mixture to prepare a cathode slurry, and applying the prepared cathode slurry on a surface of a current collector to dry the resultant structure or selectively compression-molding the prepared cathode slurry on the current collector so as to improve an electrode density. In addition, the cathode 300 may selectively include lithium oxide. Furthermore, the catalyst for oxidizing/reducing oxygen may be selectively omitted.

A current collector for the cathode 300 may have a net or mesh-shaped porous structure to promote diffusion of oxygen. The current collector may be a porous metal plate including stainless steel, nickel, or aluminum, but is not limited thereto. The current collector may comprise any current collector that is used in the art. The current collector may be covered with anti-oxidation metal or alloy film to prevent oxidation.

The cathode 300 may be prepared by mixing a cathode composition including a porous carbonaceous material and an electrolyte at room temperature.

The anode architecture 100 may be provided on a side of a case, the ion-conducting film 200 may be disposed on the lithium anode, and the cathode 300 may be disposed on the ion-conducting film 200. A gas diffusion layer including carbon paper may be disposed on the cathode 300, and a nickel (Ni) mesh, which is a current collector, is disposed thereon, and the resultant structure is pressed using a pressing member to allow air to be delivered to an air electrode, thereby fixing a cell, thereby completing the manufacture of the metal air battery 500.

For example, the metal air battery 500 may have a folded structure.

Referring to FIG. 3, a folded metal air battery 600 includes the anode architecture 100 that is folded by an angle, such as an angle of about 180 degrees, in such a manner that a portion of the protection film 20 contacts another portion thereof; the ion-conducting film 200 having one or more folded portions such as first and second folded portions 201 and 202, respectively, surrounding the anode architecture 100, and disposed on the active metal anode 10 of the anode architecture 100; and the cathode 300 having one or more folded portions, such as first and second folded portions 301 and 302, respectively, of the cathode 300, folded in the same direction as the ion-conducting film 200, surrounding the ion-conducting film 200, and disposed on the ion-conducting film 200.

The folded metal air battery 600 includes gas diffusion layers 400a and 400b disposed on the cathode 300. In the folded metal air battery 600, since the protection film 20 constitutes a surface portion of the anode architecture 100, an additional sealing member can be omitted. In the folded metal air battery 600, active metal ions may migrate through a plurality of surfaces, e.g., opposing upper and lower surfaces of the folded anode architecture 100. Accordingly, compared to a metal air battery in which an active metal ion migrates only through a single surface of a flat anode architecture, the folded metal air battery 600 may have improved capacity density. Since the folded metal air battery 600 has single anode architecture, for external, electric connection, a conductive terminal may be connected to only one end of the anode architecture. Accordingly, the folded metal air battery 600 may have improved energy density relative to a metal air battery including an anode architecture including the active metal anode 10 supported by the current collector 30, and accordingly, the energy density of the folded metal air battery 600 may be substantially increased.

For example, the folded metal air battery 600 may have a 3-dimensional (3D) structure.

Referring to FIG. 4, a 3D metal air battery 700 includes a plurality of gas diffusion layers 400a and 400b spaced apart from each other and arranged in a thickness direction of the 3D metal air battery 700. The cathode 300 may be repeatedly folded by an angle, such as an angle of about 180 degrees, in such a manner that a first surface of the cathode 300 contacts first surfaces 410a and 410b and second surfaces 420a and 420b of a plurality of gas diffusion layers 400a and 400b. The ion-conducting film 200 may be repeatedly folded at an angle of about 180 degrees in the same pattern as the cathode 300 is folded such that the ion-conducting film 200 contacts the opposite second surface of the cathode 300, the active metal anode 10 of the anode architecture 100 may be repeatedly folded at an angle of about 180 degrees in the same pattern as the ion-conducting film is folded 200 such that the active metal anode 10 contacts the ion-conducting film 200, and at the same time the anode architecture 100 may be folded by an angle of about 180 degrees between adjacent gas diffusion layers 400a and 400b to allow a contact between a portion of the oxygen-barrier protection film 20 and another portion of the oxygen-barrier protection film 20.

In the 3D metal air battery 700, the surface of the anode architecture 100 is surrounded by the protection film 20. Accordingly, an additional sealing member may be omitted. The cathode 300 may be repeatedly folded, thereby having a plurality of folded portions, such as first through sixth folded portions 301, 302, 303, 304, 305, and 306, respectively, the ion-conducting film 200 may be repeatedly folded in the same pattern as the cathode 300 is folded, thereby having a plurality of folded portions, such as first through sixth folded portions 201, 202, 203, 204, 205, and 206, respectively, and the anode architecture 100 may be repeatedly folded in the same pattern as the ion-conducting film 200 is folded, thereby having a plurality of folded portions, such as first through sixth folded portions 101, 102, 103, 104, 105, and 106, respectively. Since the 3D metal air battery 700 includes the single anode architecture, for external electric connection a conductive terminal may be connected to an end of the anode architecture. Accordingly, as illustrated in FIG. 1B, the 3D metal air battery 700 may provide improved energy density than a metal air battery including an anode architecture including the active metal anode 10 supported by the current collector 30, and accordingly, the energy density of the 3D metal air battery 700 may be substantially increased.

Each of the folded metal air battery 600 and the 3D metal air battery 700 may be stacked in a thickness direction thereof in a plurality of numbers to form a metal air battery module.

Alternatively, the electrochemical cell 500 may be a lithium ion cell.

Referring to FIGS. 2A and 2B, in the lithium ion cell 500, examples of a cathode active material in the cathode 300 may include a compound (e.g., a lithium intercalation compound) that is capable of reversibly intercalating/deintercalating lithium ions. Examples of the cathode active material may include at least one selected from lithium cobalt oxide, lithium nickel cobalt manganese oxide, lithium nickel cobalt aluminum oxide, lithium iron phosphate, and lithium manganese oxide, but are not limited thereto. The cathode active material may include any suitable cathode active material as long as the cathode active material is applicable to the art.

Examples of the cathode active material may include at least one selected from a lithium cobalt oxide expressed by the Formula LiCoO₂; a lithium nickel oxide expressed by the Formula LiNiO₂; a lithium manganese oxide expressed by the Formula Li₁₊ₓMn₂₋ₓO₄ (where, x is 0 to 0.33), LiMnO₃, LiMn₂O₃, or LiMnO₂; a lithium copper oxide expressed by the Formula Li₂CuO₂; a lithium iron oxide expressed by the Formula LiFe₃O₄; a lithium vanadium oxide expressed by the Formula LiV₃O₈; a copper vanadium oxide expressed by the Formula Cu₂V₂O₇; a vanadium oxide expressed by the Formula V₂O₅; a lithium nickel oxide expressed by the Formula LiNi₁-MₓO₂ (where, M=Co, Mn, Al, Cu, Fe, Mg, B (boron), or Ga, and x=0.01 to 0.3); a lithium manganese composite oxide expressed by the Formula LiMn₂₋ₓMₓO₂ (where, M=Co, Ni, Fe, Cr, Zn or Ta, and x=0.01 to 0.1) or Li₂Mn₃MO₈ (where, M=Fe, Co, Ni, Cu, or Zn), a lithium manganese oxide expressed by the Formula LiMn₂O₄, in which some of Li are substituted with alkaline earth metal ions; a disulfide compound; and an iron molybdenum oxide expressed by Formula Fe₂(MoO₄)₃. A combination comprising at least one of the foregoing may be used.

The cathode 300 may be formed by coating, on a current collector, a cathode active material slurry prepared by mixing a cathode active material, a conducting agent, and a binder. The conducting agent and the binder may be any suitable material for a lithium ion battery. Amounts of the conducting agent and the binder may be those used in a lithium ion battery, the details of which can be determined by one of skill in the art without undue experimentation.

A lithium ion battery may include the anode architecture 100.

A lithium ion battery 500 may include the ion-conducting film 200, and the ion-conducting film 200 may be disposed on the active metal anode 10 of the anode architecture 100.

Although not illustrated in FIGS. 2A and 2B, in the lithium ion battery 500, a separator and an electrolytic solution may be additionally disposed between the ion-conducting film 200 and the cathode 300. The separator and the electrolytic solution may respectively be the porous film and electrolytic solution that are used between the organic film/composite film and the polymer electrolyte film or between the polymer electrolyte film and the active metal anode 10 in the anode architecture 100.

A method of manufacturing an anode architecture according to an embodiment is not limited. The method of manufacturing the anode architecture may comprise providing an active metal anode having a first surface and a second surface opposing the first surface; providing the oxygen-barrier protection film; and disposing the oxygen-barrier protection film on the second surface of the active metal anode. The anode architecture may be prepared by coating a composition for forming a protection film on an active metal anode. The composition for forming a protection film may include an oxygen barrier polymer to constitute the protection film and a solvent. The oxygen barrier polymer included in the composition may be the same polymer as described above. The solvent included in the composition may be ethanol, chloroform, or the like, but is not limited thereto. The solvent may be any suitable solvent of the related art that can dissolve the oxygen barrier polymer. The coating of the composition may be by doctor-blade coating, tape casting, spraying, spin coating, or the like, but is not limited thereto. The coating may be performed by using any suitable coating method that allows the protection film to be formed on an active metal anode foil. After the coating of the composition on the active metal anode, the resultant structure may be dried to remove the solvent therefrom, thereby forming an anode architecture in which the protection film is coated on the second and side surfaces of the active metal anode. In an embodiment, after the coating of the composition, a polymerization reaction may proceed using, for example, ultraviolet (UV) light to form a polymer film.

The electrochemical cell may be a lithium primary cell or a lithium secondary cell. A shape of the electrochemical cell is not particularly limited and may have, for example, a coin shape, a button shape, a sheet shape, a laminate shape, a cylindrical shape, a flat shape, or a horn shape. In addition, the electrochemical cell may also be used as a large-sized cell used in an electric vehicle or the like. A metal of the metal air battery may be lithium.

The term “air” used in the specification is not limited to air in the atmosphere and may include at least one selected from a pure oxygen gas and combinations of gases including oxygen. A broad definition with respect to the term “air” may be applied to all applications, for example, an air cell, an air electrode, and the like.

Hereinafter, embodiments of the present disclosure will be described in further detail in connection with Examples and Comparative Examples. However, these examples are presented herein for illustrative purpose only, and do not limit the scope of the present disclosure.

### Examples

### (Manufacture of Anode Architecture)

### Example 1: TTT-4T Oxygen Barrier Film-Coated Anode Architecture

500 milligrams (mg) of pentaerythritol tetrakis(3-mercaptopropionate) (TTT) and 330 mg of 1,3,5-triallyl-1,3,5-triazine-2,4,6-trione (4T) were dissolved in 6.6 milliliters (mL) of a mixed solvent (a mixed volume ratio of 1:1) including ethanol and chloroform to obtain a mixture. 30 mg of Irgacure 369(BASF), which is a photo initiator, was added to the mixture and stirred to obtain a composition for forming a polymer film. The composition was coated to a thickness of 30 μm on a lithium foil (having a thickness of 40 μm) using a doctor blade, and then, exposed to radiation of ultraviolet (UV) light for about 15 minutes by using a UV crosslinker CL-1000 (254 nm, 10 mW/cm²) to photo-polymerize TTT and 4T, thereby forming a TTT-4T polymer film on second and side surfaces of the lithium foil, thereby completing the manufacture of an anode architecture.

The TTT-4T polymer film had a thickness of about 30 μm.

### Example 2: PVA Oxygen Barrier Film-Coated Anode Architecture

Polyvinylalcohol (weight average molecular weight: 93500)(saponification degree: 99 mol %) was dissolved in dimethyl sulfoxide (DMSO), and then, stirred at a temperature of about 60° C. for 7 hours to obtain a 5 weight percent (wt. %) polyvinylalcohol solution. The polyvinylalcohol solution was coated to a thickness of 30 μm on a lithium foil (having a thickness of 40 μm) using a doctor blade, and then, dried at a temperature of about 60° C. for about 24 hours. Subsequently, the result was vacuum dried at a temperature of about 60° C. in a vacuum oven for about 5 hours, thereby forming a PVA polymer film on second and side surfaces of the lithium foil, thereby completing the manufacture of an anode architecture.

The PVA polymer film had a thickness of about 30 μm.

### Comparative Example 1: Lithium Foil Anode

A lithium foil (having a thickness of 40 μm) was used as an anode.

### (Manufacture of Lithium Air Battery)

### Example 3: Manufacture of 2D Lithium Air Battery

### (Manufacture of Cathode)

16.32 grams (g) of polyethylene oxide (PEO, weight-average molecular weight (Mw)=600,000, Aldrich, 182028) was dissolved in 150 mL of acetonitrile to obtain a PEO solution, and then, LiTFSi was added thereto in such an amount that a molar ratio of [EO] to [Li] is 18:1. Then, the result was poured onto a Teflon dish while stirring, and then, dried at room temperature in a drying chamber for 2 days and then vacuum-dried (80° C., overnight), thereby obtaining a cathode electrolyte film from which a solvent was removed.

Carbon black (Printex®, Orion Engineered Chemicals, USA) was vacuum dried (120° C., 24 hr).

Carbon black, a polytetrafluoroethylene (PTFE) binder, and the cathode electrolyte film were estimated at a predetermined weight ratio, and then, mechanically kneaded together. The resultant mixture was subjected to a roll press to a thickness of 30 μm, and then, dried at a temperature of 60° C. in an oven, thereby forming a rectangular cathode having an area of 6 cm² (2 cm×3 cm). In the rectangular cathode, a weight ratio of carbon black to the gel electrolyte was 1:5, and the amount of the binder was 30 wt. %.

### (Manufacture of Electrolyte Film)

A porous separator (Celgard®) was impregnated with the same solution as used to prepare the cathode electrolyte film, and then, dried in a drying chamber at room temperature for 2 days and vacuum dried (60° C., overnight) to remove the solvent therefrom, thereby forming a solid electrolyte film. The thickness of the solid electrolyte film was in a range of 70 μm to 90 μm.

### (Manufacture of Lithium-Air Battery)

The electrolyte film (2 cm×3 cm) was disposed on a first surface of the cathode, and the anode architecture (2 cm×3 cm) prepared according to Example 1 was arranged on the first surface of an electrolyte film in such a manner that the lithium anode contacted the electrolyte film, thereby producing a lithium air battery having a cathode/electrolyte film/anode architecture assembly. The lithium air battery has the structure of FIG. 2.

A nickel terminal was disposed to contact a cathode, and a copper terminal was disposed to contact an anode. The copper terminal contacting the anode was connected to a side surface of a lithium foil through an oxygen barrier film.

Carbon paper (available from SGL, 35-DA), which is a gas diffusion film, was disposed on the cathode, thereby completing the manufacture of a lithium air battery. Finally, an end plate was disposed on the gas diffusion layer.

Since, in the lithium air battery, second and side surfaces of the lithium anode are surrounded by the oxygen barrier film, an additional sealing is not needed.

Referring to FIG. 1B, the current collector 30 illustrated in FIG. 1C is not disposed on the second surface 12 of the lithium anode 10 of the anode architecture 100. Accordingly, the weight of the anode architecture is substantially decreased.

### Example 4: Manufacture of Folded Lithium Air Battery

### (Manufacture of Cathode)

A cathode was manufactured in the same manner as in Example 3.

### (Manufacture of Electrolyte Film)

An electrolyte film was manufactured in the same manner as in Example 3.

### (Manufacture of Lithium-Air Battery)

The electrolyte film (2 cm×3 cm) was disposed on a first surface of the cathode, and the anode architecture (2 cm×3 cm) manufactured according to Example 1 was disposed on a first surface of an electrolyte film in such a manner that the lithium anode contacted the electrolyte film, thereby manufacturing a cathode/electrolyte film/anode architecture assembly.

Then, the cathode/electrolyte film/anode architecture assembly was folded at an angle of 180 degrees in such a manner that two points of the surface of the oxygen barrier film of the anode architecture contacted each other. Due to the folding, the area of the anode architecture was decreased in half to 3 cm² (1 cm×3 cm).

A nickel terminal was disposed to contact the cathode, and a copper terminal was disposed to contact the anode. The copper terminal contacting the anode was connected to a side surface of a lithium foil through an oxygen barrier film.

Carbon paper (available from SGL, 35-DA), which is a gas diffusion film, was disposed on the cathode, thereby completing the manufacture of a lithium air battery. The lithium air battery has the structure of FIG. 3. Finally, an end plate was disposed on the gas diffusion layer.

Since, in the lithium air battery, second and side surfaces of the lithium anode are surrounded by the oxygen barrier film, an additional sealing is not needed.

### Example 5: Manufacture of 3D Lithium Air Battery

### (Manufacture of Cathode)

A cathode was manufactured in the same manner as in Example 3, except that the area of the cathode was controlled to be 12 cm² (4 cm×3 cm).

### (Manufacture of Electrolyte Film)

An electrolyte film was manufactured in the same manner as in Example 3.

### (Manufacture of Lithium-Air Battery)

The lithium anode of the anode architecture (4 cm×3 cm) manufactured according to Example 1 was disposed in such a way that a top surface of the lithium anode was exposed, the electrolyte film (4 cm×3 cm) was disposed on the lithium anode, and the cathode (4 cm×3 cm) was disposed on the electrolyte film, thereby manufacturing an anode architecture/electrolyte film/cathode assembly (4 cm×3 cm).

Carbon paper (available from SGL, 35-DA), which is a gas diffusion film, was disposed on an end of the cathode, and then, the anode architecture/electrolyte film/cathode assembly was folded at an angle of 180 degrees in such a way that the cathode contacted a top surface of the carbon paper. Then, the anode architecture/electrolyte film/cathode assembly was folded at an angle of 180 degrees in a direction opposite to the folding direction described above in such a way that a portion of the oxygen barrier film of the anode architecture contacted another portion of the oxygen barrier film. Then, carbon paper (available from SGL, 35-DA), which is a second gas diffusion film, was disposed on the cathode, and then, the anode architecture/electrolyte film/cathode assembly was folded at an angle of 180 degrees in such a way that the cathode contacted a top surface of the carbon paper, thereby completing the manufacture of a lithium-air battery. The lithium air battery had the structure of FIG. 4. Due to the folding, the area of the anode architecture/electrolyte film/cathode assembly was decreased to a fourth of the original area thereof, that is, 3 cm² (1 cm×3 cm).

Finally, an end plate was disposed on the anode architecture.

Since, in the lithium air battery, second and side surfaces of the lithium anode are surrounded by the oxygen barrier film, an additional sealing is not needed.

### Evaluation Example 1: Evaluation on Oxygen and Water Vapor Transmission Rate

A TTT-4T film and a PVA film were prepared in the same manner as used in the anode architectures prepared according to Examples 1 and 2. Each of the TTT-4T film and the PVA film has the same thickness as used in Examples 1 and 2. The oxygen transmission rate (OTR) and water vapor transmission rate of each of the TTT-4T film and the PVA film were evaluated as follows.

The oxygen and water vapor transmission rates were measured using a continuous flow test method using MOCON Aquatran model 1 and MOCON Oxytran 2/21 instrument, respectively (MOCON Inc.) based on ASTM (D3985).

In the oxygen and water vapor transmission test of TTT-4T film and the PVA film, a sample disc area was about 1 cm², and each test was done after purging with excess nitrogen gas. Evaluation results are shown in Table 1.

TABLE 1

| | Oxygen | Water vapor |
|---|---|---|
| | transmission rate | transmission rate |
| | [cm³/m² · day] | [cm³/m² · day] |
| TTT-4T film | 89 | 103,670 |
| PVA film | 0.043 | 7,740 |

Referring to Table 1, the oxygen barrier films of the anode architectures of Examples 1 and 2 had low oxygen transmission rates and thus, excellent oxygen barrier properties.

Also, the oxygen barrier films of the anode architectures of Examples 1 and 2 had low water vapor transmission rate, and thus, excellent water vapor barrier properties.

### Evaluation Example 2: Tensile Characteristics Evaluation

The tensile strength and strain of the anode architectures of Examples 1 and 2 and the lithium foil anode of Comparative Example 1 were measured by using a tensile tester (UTM, universal testing machine, LS1SC, LLOUD Instruments. Evaluation results are shown in Table 2 and FIG. 1.

TABLE 2

| | Tensile strength | Strain |
|---|---|---|
| | [MPa] | [%] |
| Example 1 | 15.00 | 3.0 |
| Example 2 | 2.36 | 13 |
| Comparative Example 1 | 1.15 | 7.4 |

Referring to Table 1 and FIG. 1, the anode architectures of Examples 1 and 2 had greater tensile strength than the lithium foil of Comparative Example, and the anode architecture of Example 1 had lower strain than the lithium foil of Comparative Example 1.

Accordingly, the anode architectures of Examples 1 and 2 may have a greater strength than the lithium foil of Comparative Example 1, providing improved processability in manufacturing a metal air battery.

### Evaluation Example 3: Weight Evaluation

A unit weight of each of an oxygen barrier film having the same thickness as that of the oxygen barrier film (TTT-4T film and PVA film) of the anode architectures of Examples 1 and 2, a lithium foil, and a copper foil was measured. The results are shown in Table 3.

TABLE 3

| | Thickness | Weight per unit area |
|---|---|---|
| | [μm] | [mg/cm²] |
| Lithium foil | 40 | 2.30 |
| Copper foil | 10 | 8.94 |
| Oxygen barrier film (TTT-4T) | 30 | 2.62 |
| oxygen barrier film(PVA) | 30 | 3.36 |

Referring to Table 3, although the copper foil has a small thickness, it weight is great. Accordingly, when used as a current collector, the copper foil may contribute to a decrease in the energy density of a metal air battery.

However, in the case of the oxygen barrier film, although its thickness is three times as high as that of the copper foil, its weight is as low as about 30% of the copper foil. Accordingly, the oxygen barrier film may contribute to a substantial increase in the energy density of a metal air battery that uses the oxygen barrier film instead of a copper current collector.

### Evaluation Example 4: Charge and Discharge Characteristics Evaluation

At a temperature of 60° C. and in 1 atmosphere (atm) oxygen atmosphere, the lithium air batteries manufactured according to Examples 3 to 5 were charged and discharged once with a constant current of 0.24 mA/cm² in a voltage range of 1.7 to 4.2 V (vs. Li) and it is confirmed that the lithium air batteries manufactured according to Examples 3 to 5 can operate as an electrochemical cell.

According to an aspect of the present disclosure, due to the inclusion of an anode architecture including a light-weight oxygen-barrier protection film surrounding second and side surfaces of a lithium metal anode, a formed lithium air battery may have increased energy density per unit weight, and an additional sealing may be omitted.

It should be understood that embodiments described herein should be considered in a descriptive sense only and not for purposes of limitation. Descriptions of features, advantages, or aspects within each embodiment should typically be considered as available for other similar features, advantages, or aspects in other embodiments.

While an embodiment has been described with reference to the figures, it will be understood by those of ordinary skill in the art that various changes in form and details may be made therein without departing from the spirit and scope as defined by the following claims.

What is claimed is:

1. An anode architecture comprising:
an active metal anode having a first surface and a second surface opposing the first surface; and
an oxygen-barrier protection film surrounding the second surface of the active metal anode,
wherein the oxygen-barrier protection film is an organic film or an organic-inorganic composite film.

2. The anode architecture of claim 1,
wherein the active metal anode further comprises a side surface between the first surface and the second surface, and
wherein the oxygen-barrier protection film comprises at least one folded portion that contacts the side surface of the active metal anode.

3. The anode architecture of claim 1, wherein the oxygen-barrier protection film does not surround the first surface of the active metal anode.

4. The anode architecture of claim 1, wherein the oxygen-barrier protection film has an oxygen transmission rate of 1,000 cubic centimeters per meter per day or less.

5. The anode architecture of claim 1, wherein the oxygen-barrier protection film has a water vapor transmission rate of 500,000 cubic centimeters per meter per day or less.

6. The anode architecture of claim 1, wherein the oxygen-barrier protection film is inert with respect to an electrode reaction.

7. The anode architecture of claim 1, wherein the oxygen-barrier protection film is a non-ion conducting film.

8. The anode architecture of claim 1, wherein the oxygen-barrier protection film does not comprise a lithium salt.

9. The anode architecture of claim 1, wherein the oxygen-barrier protection film has a thickness of about 0.1 micrometers to about 100 micrometers.

10. The anode architecture of claim 1, wherein the anode architecture has a tensile strength of 2 megapascals or greater.

11. The anode architecture of claim 1, wherein the anode architecture has a strain of 7% or less.

12. The anode architecture of claim 1, wherein the oxygen-barrier protection film comprises at least one selected from polyvinylalcohol and a polyvinylalcohol blend.

13. The anode architecture of claim 1, wherein the oxygen-barrier protection film comprises at least one selected from
a first polymerization product of at least one multi-functional monomer selected from a multi-functional (meth)acryl monomer and a multi-functional vinyl monomer; and
a second polymerization product of.
a polythiol having three or four thiol groups, and
at least one multi-functional monomer selected from a multi-functional (meth)acryl monomer and a multi-functional vinyl monomer.

14. The anode architecture of claim 1, wherein the oxygen-barrier protection film comprises at least one selected from
polyvinylalcohol;
a blend of polyvinylalcohol and at least one polymer selected from polymethylmethacrylate, polymethylacrylate, polyethyl methacrylate, polyethylacrylate, polypropylmethacrylate, polypropylacrylate, polybutylacrylate, polybutylmethacrylate, polypentylmethacrylate, polypentylacrylate, polycyclohexylmethacrylate, polycyclohexylacrylate, polyhexylmethacrylate, polyhexylacrylate, polyglycidylacrylate, polyglycidylmethacrylate, and polyacrylonitrile; and
a polymerization product of at least one selected from pentaerythritol tetrakis(3-mercaptopropionate) and 1,3,5-triallyl-1,3,5-triazine-2,4,6-trione.

15. The anode architecture of claim 1, wherein the anode architecture does not comprise a current collector between the active metal anode and the oxygen-barrier protection film.

16. An electrochemical cell comprising:
the anode architecture of claim 1;
an ion-conducting film disposed on the active metal anode of the anode architecture; and
a cathode disposed on the ion-conducting film.

17. The electrochemical cell of claim 16, wherein the electrochemical cell is a metal air battery.

18. The electrochemical cell of claim 16, further comprising a gas diffusion layer disposed on the cathode,
wherein
the anode architecture is folded by an angle of about 180 degrees to provide a contact between a portion of the oxygen-barrier protection film and another portion of the oxygen-barrier protection film;
the ion-conducting film comprises at least one folded portion, surrounds the anode architecture, and is disposed on the active metal anode of the anode architecture; and
the cathode is folded in a same direction as a direction of the ion-conducting film, comprises at least one folded portion, surrounds the ion-conducting film, and is disposed on the ion-conducting film.

19. The electrochemical cell of claim 16, further comprising
a plurality of gas diffusion layers spaced apart from one another in a thickness direction of the electrochemical cell,
wherein the cathode is repeatedly folded by an angle of about 180 degrees to provide a first surface thereof which contacts opposite surfaces of each of the gas diffusion layers,
the ion-conducting film is repeatedly folded by an angle of about 180 degrees in a same pattern as a pattern of the cathode, and contacts a second surface of the cathode, which is opposite to the first surface of the cathode,
the active metal anode of the anode architecture is repeatedly folded by an angle of about 180 degrees in a same pattern as the pattern of the ion-conducting film, to contact the ion-conducting film, and
the anode architecture is folded by an angle of about 180 degrees between adjacent gas diffusion layers of the plurality of gas diffusion layers to provide a contact between a first portion of the oxygen-barrier protection film and second portion of the oxygen-barrier protection film.

20. A method of manufacturing the anode architecture of claim 1, the method comprising:
providing an active metal anode having a first surface and a second surface opposing the first surface;
providing the oxygen-barrier protection film; and
disposing the oxygen-barrier protection film on the second surface of the active metal anode.
